(19) United States
(12) Patent Application Publication
(10) Pub. No.: US 2024/0169097 A1
(43) Pub. Date: May 23, 2024

(54) DATA AUTHENTICITY PROVING SYSTEM AND DATA AUTHENTICITY PROVING METHOD

(71) Applicant: DENSO CORPORATION, Kariya-city (JP)

(72) Inventors: HARUHIKO NAMIKI, Kariya-city (JP); TAKUMA KAWAMURA, Kariya-city (JP); ATSUYA TANAKA, Kariya-city (JP); TAKAKAZU MURAKAMI, Kariya-city (JP); TATSUYA OKABE, Kariya-city (JP)

(21) Appl. No.: 18/430,519

(22) Filed: Feb. 1, 2024

Related U.S. Application Data
(63) Continuation of application No. PCT/JP2022/021858, filed on May 30, 2022.

(30) Foreign Application Priority Data
Aug. 6, 2021 (JP) 2021-129532

(51) Int. Cl. G06F 21/64; H04L 9/32

(52) U.S. Cl. CPC G06F 21/64; H04L 9/3236

(57) ABSTRACT

A data authenticity proving system calculates a hash value A and a hash value B from an evidence data transmitted from a terminal device at respectively different timings, and, when the hash value A and the hash value B are the same, registers the evidence data by storing the evidence data in a storage device. In case that the evidence data has been tampered with during a time between a timing of receiving the evidence data from the terminal device and a timing of registering the evidence data in the storage device, the hash value A and the hash value B take respectively different values, thereby registration of the evidence data will not be performed.

### CROSS REFERENCE TO RELATED APPLICATION

The present application is a continuation application of International Patent Application No. PCT/JP2022/021858 filed on May 30, 2022, which designated the U.S. and claims the benefit of a priority right of Japanese Patent Application JP 2021-129532 filed on Aug. 6, 2021, and all contents in the above applications are incorporated herein by reference.

### TECHNICAL FIELD

The present disclosure relates to a data authenticity proving system and a data authenticity proving method.

### BACKGROUND

There have been cases in which proof/verification is required that previously stored data (digital data) has not been tampered with.

There has been known an evidence data storage system for preventing troubles between a service provider and a service user or between service users when providing a service. Users of this evidence data storage system can display evidence data stored on the server on the display device of their own terminals, and this evidence data can be used as material to solve problems when troubles occur.

Here, even if data can be prevented from being tampered with or fraudulent by technology such as blockchain, it is assumed that the data is not tampered with at the time it is registered for storage. Although a user of the evidence data storage system stores imaging data as evidence data in a server, it is not possible for such a user to prove that the data has not been tampered with at the time of registration for storage.

### SUMMARY

A data authenticity proving system according to an aspect of the present disclosure is one that is configured to prove that data received by a server from a terminal device operated by a user is not tampered with. The data authenticity proving system includes:
a first authentication value calculator that is configured to calculate a first authentication value that is a value uniquely associated with the data at a first timing;
a second authentication value calculator that is configured to calculate a second authentication value that is a value uniquely associated with the data at a second timing different from the first timing of calculating the first authentication value by the first authentication value calculator;
a comparator that is configured to compare the first authentication value and the second authentication value; and
a register that is configured to register the data by storing the data in a storage device when the comparator determines that the first authentication value is equal to second authentication value.

### BRIEF DESCRIPTION OF THE DRAWINGS

Objects, features, and advantages of the present disclosure will become more apparent from the following detailed description made with reference to the accompanying drawings, in which:

FIG. 1 is a schematic configuration diagram of a data authenticity proving system in a first embodiment;

FIG. 2 is a functional block diagram of a terminal device and a server in the first embodiment;

FIG. 3 is a flowchart showing a flow of an evidence data transmission process in the first embodiment;

FIGS. 4A and 4B are, respectively, an example of data generated in the evidence data transmission process in the first embodiment;

FIG. 5 is a flowchart showing a flow of a hash value calculation process in the first embodiment;

FIGS. 6A and 6B are, respectively, an example of data generated in the hash value calculation process in the first embodiment;

FIG. 7 is a flowchart showing a flow of an evidence data confirmation process in the first embodiment;

FIG. 8 is an example of data generated in the evidence data confirmation process in the first embodiment;

FIG. 9 is a flowchart showing a flow of an evidence data registration process in the first embodiment;

FIGS. 10A, 10B and 10C are, respectively, an example of data generated in the evidence data registration process in the first embodiment;

FIG. 11 is a functional block diagram of a terminal device and a server in a second embodiment;

FIG. 12 is a functional block diagram of a terminal device and a server in a third embodiment;

FIG. 13 is a schematic diagram showing a method for calculating a modified hash value in the third embodiment;

FIG. 14 is a schematic diagram showing a hash value calculation method in a fourth embodiment;

FIG. 15 is a flowchart showing a flow of an evidence data transmission process in a fifth embodiment; and

FIG. 16 is a flowchart showing a flow of a QR code pre-issuance process in a sixth embodiment.

### DETAILED DESCRIPTION

Next, a relevant technology will be described first only for understanding the following embodiments. It is one objective of the present disclosure to provide a data authenticity proving system and a data authenticity proving method that can prove that registered data is authentic data.

A data authenticity proving system according to a first aspect of the present disclosure is one that is configured to prove that data received by a server from a terminal device operated by a user is not tampered with. The data authenticity proving system includes:
a first authentication value calculator that is configured to calculate a first authentication value that is a value uniquely associated with the data at a first timing;
a second authentication value calculator that is configured to calculate a second authentication value that is a value uniquely associated with the data at a second timing different from the first timing of calculating the first authentication value by the first authentication value calculator;
a comparator that is configured to compare the first authentication value and the second authentication value; and
a register that is configured to register the data by storing the data in a storage device when the comparator determines that the first authentication value is equal to second authentication value.

According to such a configuration, the first authentication value and the second authentication value are calculated from the same, original data to be registered at different timings, and, when the first authentication value and the second authentication value are the same, the data is stored in the storage device, for registration. Note that the authentication value here is, for example, a hash value. Then, if the data is tampered with during a time between reception from the terminal device and registration in the storage device, the first authentication value and the second authentication value take respectively different values, and registration of the data will not be performed. Therefore, according to such a configuration, it is possible to prove that the registered data is authentic data.

A data authenticity proving method according to a second aspect is one for proving that data received by a server from a terminal device operated by a user is not tampered with. The data authenticity proving method includes:
calculating a first authentication value that is a value uniquely associated with the data and is calculated at a first timing;
calculating a second authentication value that is a value uniquely associated with the data and is calculated at a second timing different from the first timing of calculating the first authentication value by the first authentication value calculator;
comparing the first authentication value and the second authentication value; and
registering the data by storing the data in a storage device when the comparator determines that the first authentication value is equal to the second authentication value.

According to the present disclosure, it is possible to prove that the registered data is an authentic data.

Embodiments of the present disclosure will be described below with reference to the drawings. Note that the embodiment described below shows an example of implementing the present disclosure, and the present disclosure is not limited to the specific configuration described below. In implementing the present disclosure, specific configurations depending on the embodiments may be adopted as appropriate.

### First Embodiment

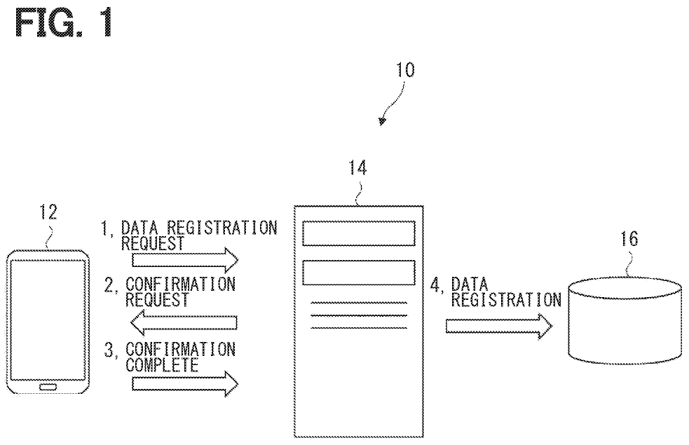

FIG. 1 is a schematic configuration diagram of a data authenticity proving system 10 of the present embodiment. The data authenticity proving system 10 of the present embodiment includes a terminal device 12 used by a user, a server 14 that authenticates evidence data, and a storage device 16 that stores the evidence data. The terminal device 12 is preferably a device equipped with a camera, a GPS (Global Positioning System), various sensors, an arithmetic unit, a storage area, a communication device, and the like, such as a surveillance camera with a sensor, a smartphone, a tablet type terminal, a laptop computer, a desktop computer equipped with a camera, a drone, a robot, smart glasses, and the like.

The data authenticity proving system 10 of the present embodiment is a third-party data generation system that generates data that requires authentication under the management of the present system in the terminal device 12 operated by a user, and proves that the data forcibly transmitted from the terminal device 12 to the server 14 has not tampered. That is, before the data generated by the data authenticity proving system 10 is stored in the storage device 16, not only a person who illegally accesses the terminal device 12 but also a user of the terminal device 12 cannot tamper with the evidence data.

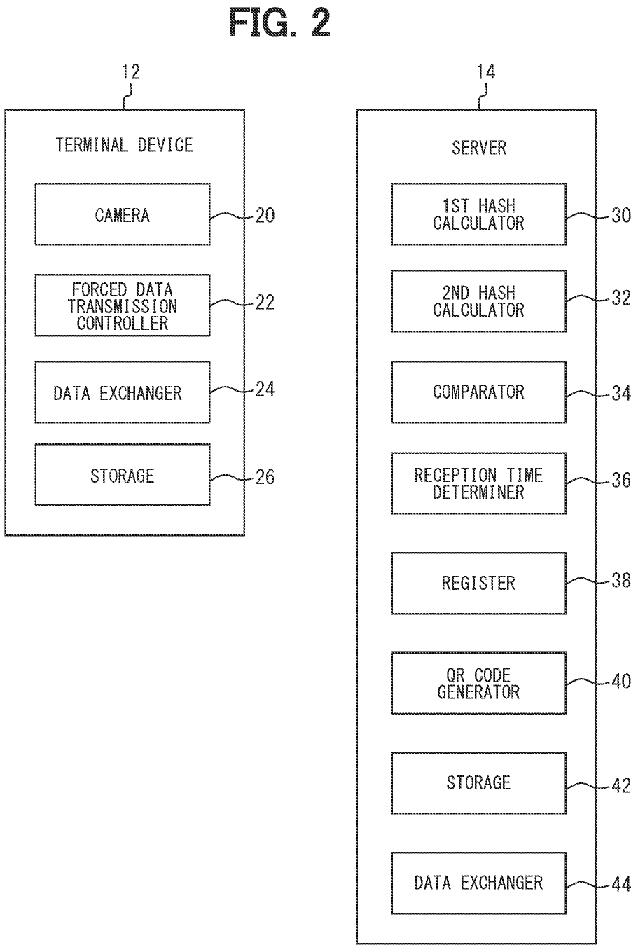

The data authenticity proving system 10 of the present embodiment treats, for example, still image data (hereinafter referred to as “captured data”) acquired by a camera 20 (see FIG. 2) included in the terminal device 12, a capture time of the captured data, a capture position and the like as evidence data, and registers the evidence data by storing the evidence data in the storage device 16 via the server 14.

The server 14 of the present embodiment is provided in the cloud or on-premises, and can be accessed from the terminal device 12. The server 14 of the present embodiment performs data authenticity proving process to prove that the evidence data to be registered is authentic and free from falsification, by calculating authentication values calculated from the evidence data multiple times at different timings for the evidence data stored in the storage device 16, and by determining whether the multiple authentication values are the same. That is, the data authenticity proving system 10 of the present embodiment proves that the evidence data has not been tampered with while registering the evidence data transmitted from the terminal device 12.

Note that the authentication value calculated from the evidence data in the present embodiment is a hash value, for example.

The storage device 16 of the present embodiment is provided in the cloud or on-premises, and can also be accessed from the terminal device 12. Examples of the storage device 16 of the present embodiment include a storage, a database, and a blockchain. Evidence data such as captured data is stored in the storage. The database stores evidence information such as GPS information and date/time information of the captured data, a path of the evidence data stored in the storage, and the like. Basic information of the evidence data is stored in the blockchain. Note that in the present embodiment, the storage, the database, and the blockchain are included in one storage device 16, but the storage, the database, and the blockchain may be stored separately in different storage devices.

An overview of the data authenticity proving process of the present embodiment will be explained with reference to FIG. 1. First, the terminal device 12 transmits evidence data to the server 14 for a registration request based on a user's operation. The server 14 temporarily stores the received evidence data (hereinafter referred to as “temporary storage”), and calculates a hash value A based on this evidence data. After that, the server 14 transmits a confirmation request to the terminal device 12 to let the user confirm the evidence data. After the user completes the confirmation, the terminal device 12 calculates a hash value B from the temporarily stored evidence data, and compares the hash value A and the hash value B. The server 14 registers the evidence data by storing the evidence data in the storage device 16 when the hash value A and the hash value B are the same. Note that the evidence data registered in the storage device 16 is stored using a blockchain, for example.

FIG. 2 is a functional block diagram showing the functions of the server 14 of the present embodiment.

In addition to the camera 20, the terminal device 12 includes a forced data transmission controller 22, a data exchanger 24, and a storage 26.

The forced data transmission controller 22 controls the data exchanger 24 to transmit the captured data to the server 14 immediately after the terminal device 12 generates the evidence data, or in the present embodiment, immediately after the camera 20 acquires the captured data. The forced transmission here refers to transmitting the evidence data to the server 14 without acquiring permission from the user operating the terminal device 12. Note that when the evidence data is transmitted to the server 14 by the forced data transmission controller 22, the evidence data is not stored in the terminal device 12.

The data exchanger 24 transmits and receives data to and from other information processing devices such as the server 14, and to and from printing devices, and the like.

The storage 26 stores various programs executed by the terminal device 12 and various data.

The server 14 includes a first hash value calculator 30, a second hash value calculator 32, a comparator 34, a reception time determiner 36, a register 38, a QR code generator 40, a storage 42, and a data exchanger 44.

The first hash value calculator 30 calculates the hash value A that is a value unique to the evidence data.

The second hash value calculator 32 calculates the hash value B, which is a value unique to the evidence data, at a timing different from the calculation of the hash value A by the first hash value calculator 30.

Note that the first hash value calculator 30 and the second hash value calculator 32 may be a single hash value calculator.

The comparator 34 compares the hash value A and the hash value B, and determines whether the hash value A and the hash value B are the same.

The reception time determiner 36 determines that the received evidence data is not authentic when a difference between the generation time of the evidence data and the reception time of the evidence data is a predetermined amount of time or more. Note that this predetermined amount of time is, for example, 5 seconds.

The register 38 registers the evidence data by storing the evidence data in the storage device 16 when the comparator 34 determines that the hash value A and the hash value B are the same.

The QR code generator 40 generates an information code indicating registration information of the evidence data stored in the storage device 16. In the present embodiment, the information code is a QR code (registered trademark), for example, but the information code is not limited to such form, e.g., may also be other two-dimensional code such as an SQRC (registered trademark), or one-dimensional code such as a bar code A user or the like can check the registered evidence data by reading this QR code with the terminal device 12 or the like.

The storage 42 stores various data such as a program for performing the data authenticity proving process, each data received from the terminal device 12, and data generated in the data authenticity proving process.

The data exchanger 44 transmits and receives data to and from other information processing devices such as the terminal device 12, the storage device 16 and the like.

Next, various processes included in the data authenticity proving process will be explained with reference to a flowchart. Note that each of the processes included in the data authenticity proving process is performed by a program stored in a storage medium such as the storage 26 included in the terminal device 12, the storage 42 included in the server 14 and the like. By executing the program, a method corresponding to the program is performed.

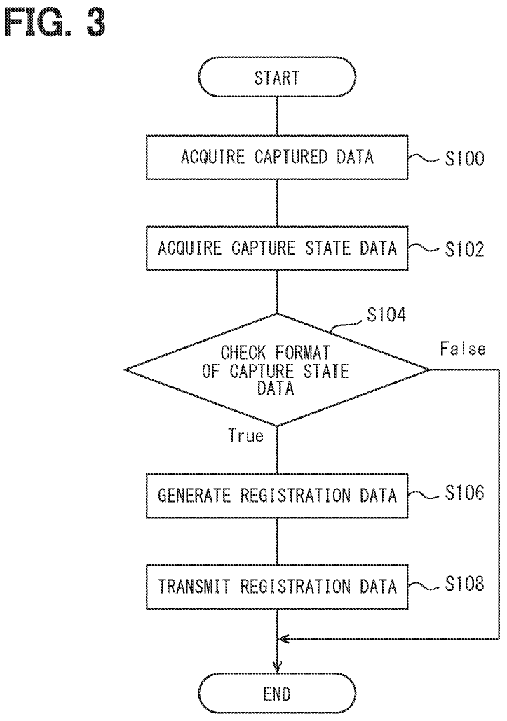

FIG. 3 is a flowchart showing a flow of an evidence data transmission process. The evidence data transmission process is a process of transmitting captured data as evidence data from the terminal device 12 to the server 14, and is executed by the terminal device 12. Note that when performing the evidence data transmission process, it is performed by starting an application installed in advance on the terminal device 12, or by starting a browser and accessing the application for transmitting the evidence data.

First, in step S100, a user uses a camera function of the terminal device 12 to capture a subject, and acquires captured data to be used as evidence data.

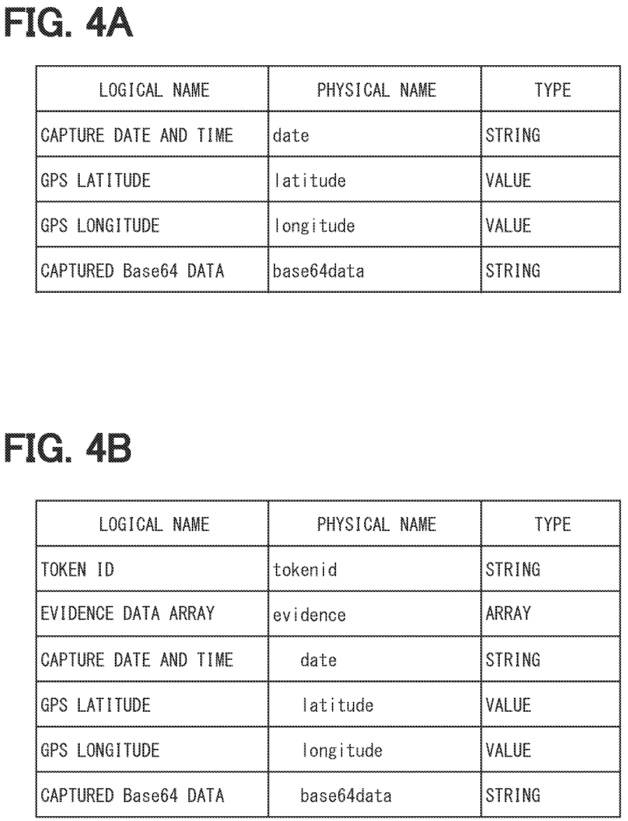

In the next step S102, capture state data indicating a state when the captured data was acquired is acquired. As shown in FIG. 4A, the capture state data is data that includes, for example, Base64 data acquired by converting the captured data (hereinafter referred to as “captured Base64 data”), a capture date and time of the captured data, and a capture location. Note that the capture location is a latitude and a longitude acquired by a GPS function included in the terminal device 12.

In the next step S104, the format of the capture state data is checked, and if the format check is successful, the process shifts to step S106, and if it is unsuccessful, the evidence data transmission process ends. Note that the format check is, for example, checking whether the items and format of the capture state data satisfy predetermined conditions. Note that the same applies to format checks in each process described later.

In step S106, registration data is generated. The registration data is data acquired by adding an ID (token ID) to the capture state data, as shown in FIG. 4B. Note that an evidence data array in FIG. 4B has the capture date and time, the capture location, and the captured Base64 data included in the capture state data.

In the next step S108, the forced data transmission controller 22 controls the data exchanger 24 to transmit the registration data to the server 14, thereby transmitting the registration data to the server 14 and ending the evidence data transmission process.

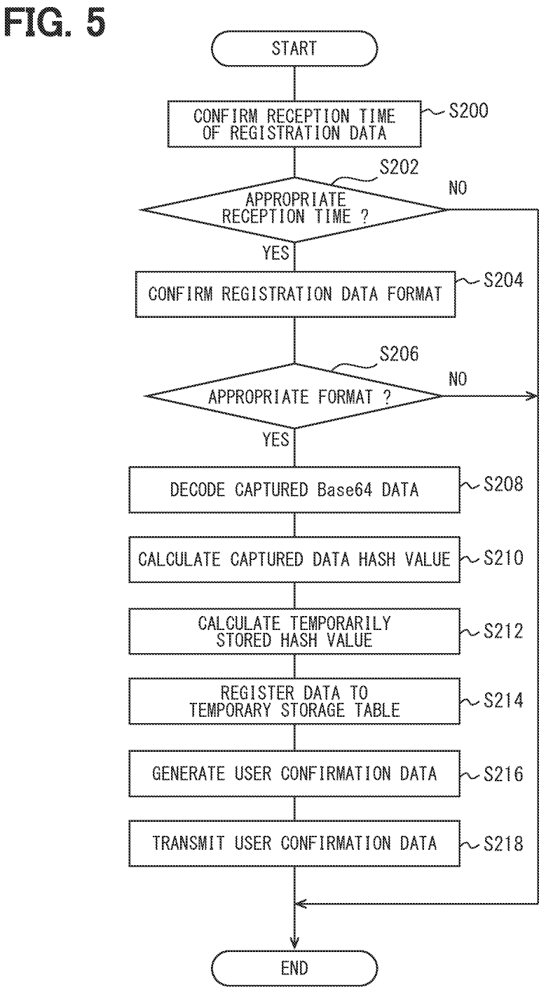

FIG. 5 is a flowchart showing a flow of a hash value calculation process performed by the server 14 that has received the registration data.

First, when the server 14 receives the registration data from the terminal device 12, in step S200, the reception time determiner 36 confirms the reception time of the registration data.

In the next step S202, the reception time determiner 36 determines whether the reception time of the received registration data is appropriate, and in case of a positive determination, the process shifts to step S204, and in case of a negative determination, the hash value the calculation process ends. The reception time determiner 36 determines that, if the capture time read from the registration data and the reception time of the registration data differ by a predetermined amount of time or more, it is inappropriate, that is, the evidence data indicated by the received registration data is not authentic. The case where the capture time and the reception time differ by the predetermined amount of time or more indicates that the captured data may have been tampered with in some way.

In the next step S204, the format of the registration data is confirmed. In the next step S206, it is determined whether the format is appropriate, and if the determination is positive, the process shifts to step S208, while if the determination is negative, the hash value calculation process ends.

Note that if a negative determination is made in step S202 or step S204 and the hash value calculation process is terminated, the server 14 transmits failure information to the terminal device 12.

In the next step S208, the captured Base64 data included in the registration data is decoded and stored in the storage 42. The path of the captured data stored in the storage 42 is acquired as a temporary storage path.

In the next step S210, the first hash value calculator 30 calculates a hash value of the captured data acquired by decoding (hereinafter referred to as “captured data hash value”).

In the next step S212, the first hash value calculator 30 calculates a temporarily stored hash value. The temporarily stored hash value is a value acquired by formatting the capture date and time of the captured data, GPS latitude, GPS longitude, a captured data hash value, and the temporary storage path into a character string, and hashing this character string. Note that this temporarily stored hash value corresponds to the hash value A described above. Note that formatting here refers to combining alphabets and numbers constituting the capture date and time of the captured data, the GPS latitude, the GPS longitude, the captured data hash value, and the temporary storage path into one data.

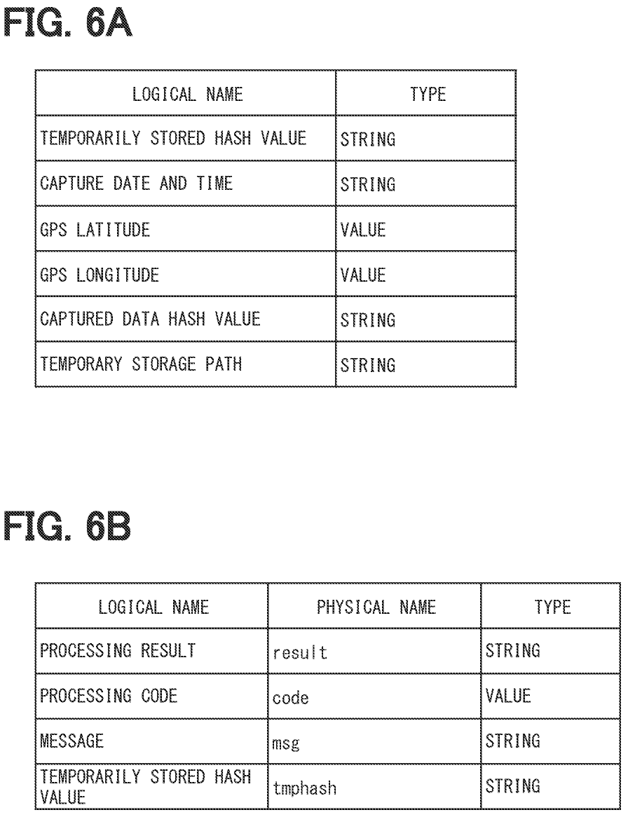

In the next step S214, various data are registered in a temporary storage table and stored in the storage 42. As shown in FIG. 6A, the temporary storage table is data in which the temporarily stored hash value, capture date and time of the captured data, the GPS latitude, the GPS longitude, the captured data hash value, and the temporary storage path are recorded.

In the next step S216, user confirmation data is generated. As shown in FIG. 6B, the user confirmation data is data composed of a process result, a process code, a message, and a temporarily stored hash value. The user confirmation data is data for allowing the user to confirm the captured data to be registered, and is a return value.

In the next step S218, user confirmation data is transmitted to the terminal device 12 via the data exchanger 44, and the hash value calculation process ends.

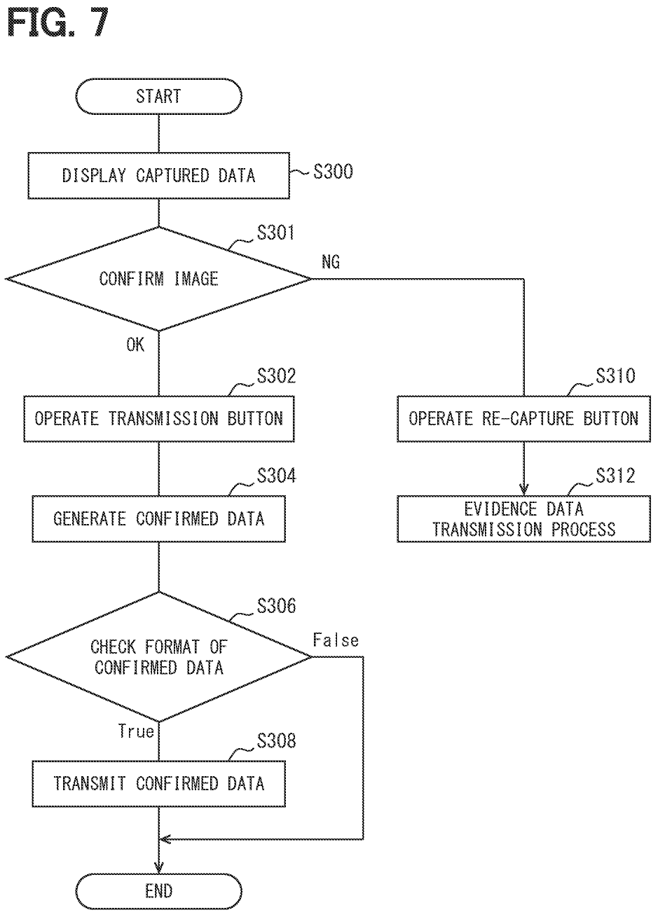

FIG. 7 is a flowchart showing a flow of an evidence data confirmation process performed by the terminal device 12 when the terminal device 12 receives the user confirmation data. Note that, as described above, in the present embodiment, the evidence data is generated in the terminal device 12, the evidence data is forcibly transmitted to the server 14, and no evidence data is left in the terminal device 12. Therefore, the user confirms the evidence data (captured data in the present embodiment) through the evidence data confirmation process.

First, in step S300, captured data is displayed on a display of the terminal device 12. In order to display the captured data on the display, for example, a temporary storage table stored in the server 14 is read out based on the temporarily stored hash value included in the user confirmation data that is the return value. Then, the captured data indicated by the temporary storage path included in the temporary storage table is read out and displayed on the display.

Note that a comment field, a send button, and a recapture button are displayed on the display of the terminal device 12 along with the captured data. In the comment field, the user can enter any text or numbers. The send button is operated (depressed) when the user confirms that the captured data displayed on the display is appropriate. On the other hand, the recapture button is operated (depressed) when the user determines that the captured data displayed on the display is not appropriate.

In the next step S301, the user confirms an image of the captured data displayed on the display, and if the user determines that the captured data is appropriate, the process shifts to step S302, and the user operates the send button. On the other hand, if the user determines that the captured data is not appropriate, the process shifts to step S310, and the user operates the recapture button.

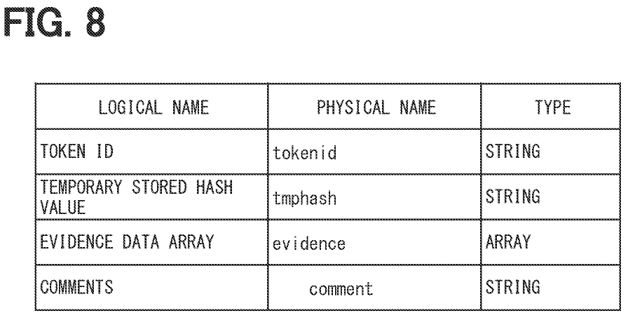

In step S304, which follows step S302, confirmed data is generated. As shown in FIG. 8, the confirmed data is data consisting of a token ID, a temporarily stored hash value, and a comment. The token ID is the same as the token ID of the registration data shown in FIG. 4B. The temporarily stored hash value is the same as the temporarily stored hash value of the user confirmation data shown in FIG. 6B. The comment is a character string entered by the user in the comment field, and is included as part of the evidence data array.

In the next step S306, the format of the generated confirmed data is checked, and if the format check is successful, the process shifts to step S308, and if it is unsuccessful, the evidence data confirmation process ends.

In step S308, the confirmed data is transmitted to the server 14, and the evidence data confirmation process ends.

On the other hand, in step S312 that follows step S310, the evidence data transmission process described using FIG. 3 is performed, the captured data to re-generate the evidence data is acquired, and the acquired captured data is transmitted to the server 14 as the evidence data. Thereafter, the hash value calculation process shown in FIG. 5 is performed, and the process returns to step S300 again.

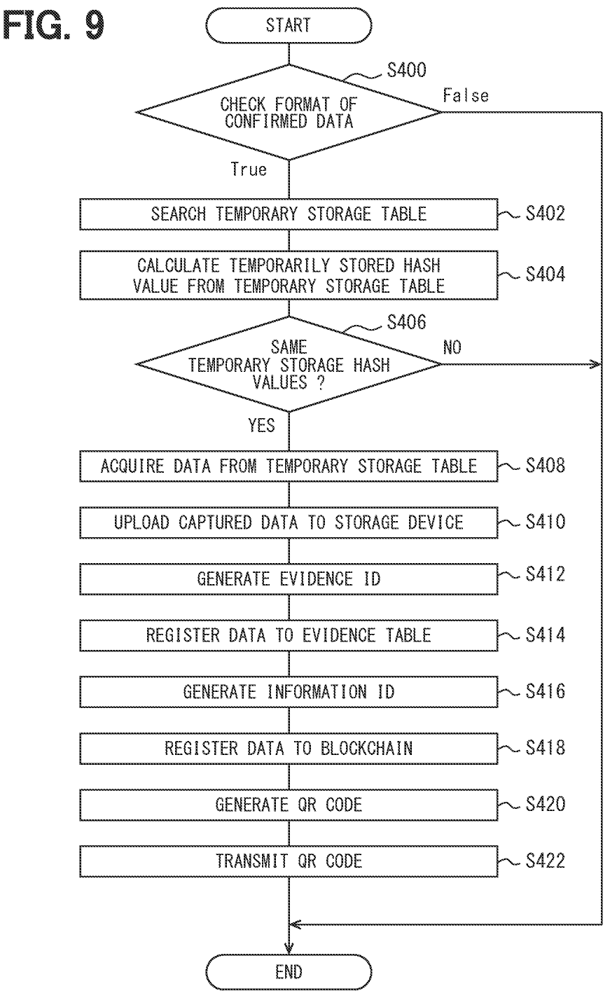

FIG. 9 is a flowchart showing a flow of an evidence data registration process performed by the server 14 when the server 14 receives the confirmed data.

First, in step S400, the format of the received confirmed data is checked, and if the format check is successful, the process shifts to step S402, and if it is unsuccessful, the evidence data registration process ends.

In the next step S402, a temporary storage table containing the same temporarily stored hash value as the temporarily stored hash value included in the confirmed data is searched and read from the storage 42. If the temporary storage table cannot be read from the storage 42, it means that either the confirmed data or the temporary storage table stored in the storage 42 has been tampered with.

In the next step S404, the capture date and time, the GPS latitude, the GPS longitude, the captured data hash value, and the temporary storage path are read from the read temporary storage table, and by formatting these into a character string and hashing them, the second hash value calculator 32 calculates a temporarily stored hash value. The temporarily stored hash value calculated in step S404 corresponds to the hash value B described above.

In the next step S406, the comparator 34 compares the temporarily stored hash value (hash value A) included in the confirmed data and the temporarily stored hash value (hash value B) calculated in step S404, and it is determined whether these hash values are the same. If they are the same, that is, a positive determination is made in step S406, the process shifts to step S408, and if they are not the same, that is, a negative determination is made, the evidence data registration process ends.

In the next step S408, various data are acquired from the temporary storage table.

In the next step S410, the captured data is read from the storage 42 using the temporary storage path acquired from the temporary storage table. Then, the register 38 uploads the captured data to the storage device 16 as the evidence data, and the storage device 16 stores (i.e., registers) the captured data in the storage. The path of the storage that stores the captured data is stored in the database of the storage device 16, and this path is acquired as a registered evidence file storage path.

In the next step S412, the register 38 generates an evidence ID. The evidence ID is, for example, a Merkle Root of a value up to a name of the registrant of the evidence data, a registration date and time, the capture date and time, the GPS latitude, the GPS longitude, the comment, the captured data hash value, the registered evidence file storage path, and a deletion flag, is a hash value.

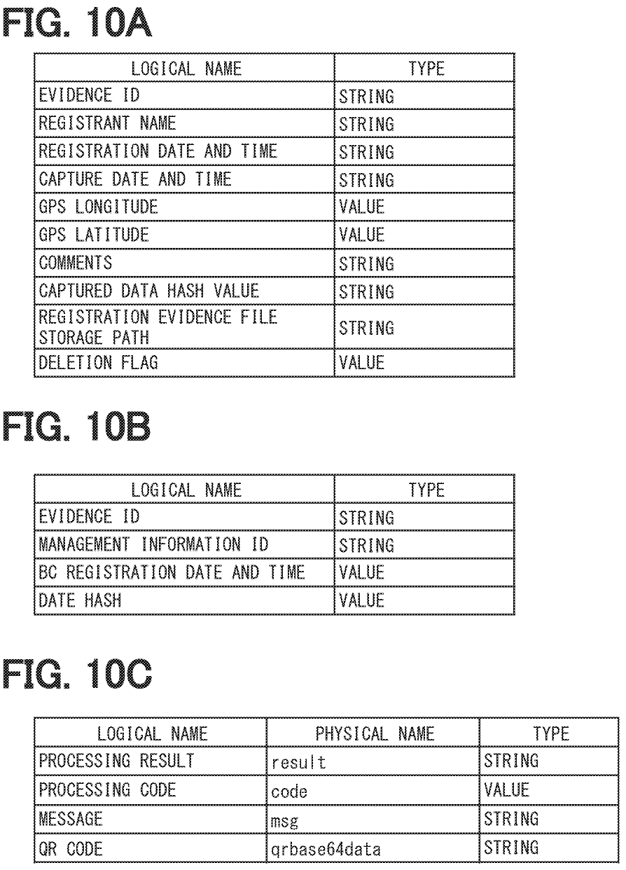

In the next step S414, an evidence table shown in FIG. 10A registers the evidence ID, the registrant name, the registration date and time, the capture date and time, the GPS latitude, the GPS longitude, the comment, the captured data hash value, the registered evidence file storage path, and the deletion flag. This evidence table is stored in the storage device 16.

In the next step S416, the register 38 generates an information ID (key value). As shown in FIG. 10B, the information ID is a Merkle root of the evidence ID, the management information ID, the registration date and time, and a date hash, and is a hash value.

In the next step S418, the register 38 registers the evidence data to the blockchain.

In the next step S420, the QR code generator 40 generates a QR code based on the information ID.

In the next step S422, the data exchanger 44 transmits QR code data shown in FIG. 10C to the terminal device 12, and ends the evidence data registration process. Note that the QR code indicated by the QR code data is, for example, data in Base64 format, but is not limited to such format, and may be data in other formats.

The user of the terminal device 12 that has received the QR code data prints the QR code and attaches it to a product or its packaging, for example. Then, a purchaser of the product can read the evidence data (captured data) by reading the pasted QR code with an evidence data reading application.

In addition, when reading the captured data using the QR code, the captured data hash value of the captured data may be calculated, for comparing this hash value with the captured data hash value included in the evidence table to determine whether they are the same.

Specifically, the captured data is read from the storage based on the registered evidence file storage path included in the read evidence table, and the captured data hash value is calculated. Then, the captured data hash value is compared with the captured data hash value recorded in the evidence table to determine whether they are the same. If they are the same, the captured data read from the blockchain is displayed. On the other hand, if they are not the same, the captured data registered in the blockchain may have possibly been tampered with, thereby the captured data will not be displayed.

As described above, the data authenticity proving system 10 of the present embodiment transmits the evidence data generated by the terminal device 12 to the server 14 without storing it in the terminal device 12. The server 14 calculates the hash value A and the hash value B from the received evidence data at different timings, and, when the hash value A and the hash value B are the same, registers the evidence data by storing it in the storage device 16. If the evidence data is tampered with during the time between (a) reception from the terminal device 12 and (b) registration in the storage device 16, the hash value A and the hash value B take respectively different values, and registration of the evidence data will not be performed. Therefore, according to the data authenticity proving system 10 of the present embodiment, it is possible to prove that the registered evidence data is authentic data.

Further, in the present embodiment, a mode in which the evidence data confirmation process shown in FIG. 7 is performed has been described, but a mode in which the evidence data confirmation process is not performed may also be adopted. Even in such case, the calculation of the hash value B is performed at a different timing from the calculation of the hash value A, and when the hash value A and the hash value B are the same, registration of the evidence data is performed by storing the data in the storage device 16.

### Second Embodiment

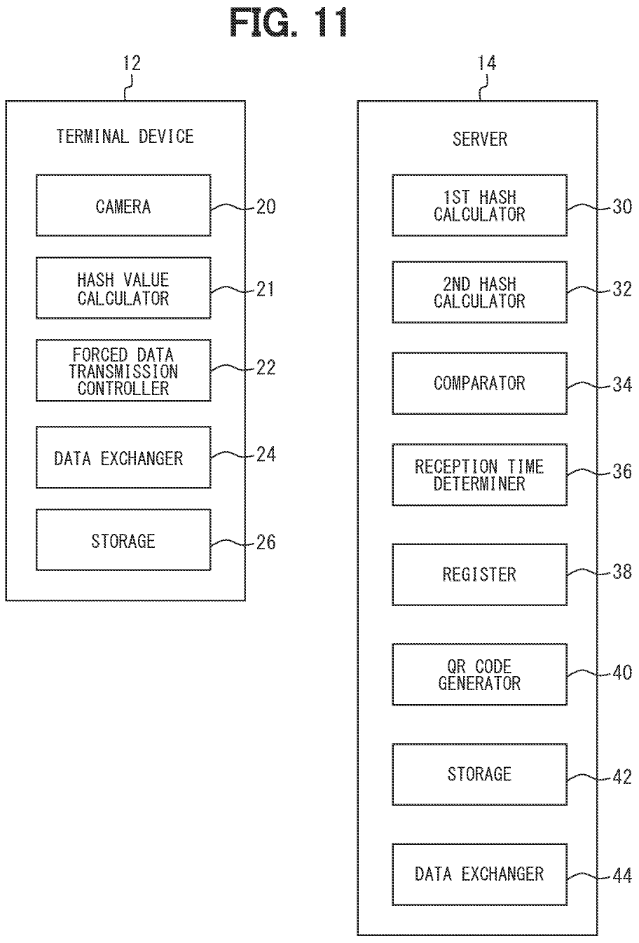

A data authenticity proving system 10 of the present embodiment will be described in the following. FIG. 11 is a schematic configuration diagram of a data authenticity proving system 10 of the present embodiment. Note that configurations in FIG. 11 that are similar to those in FIG. 2 are designated by the same reference numerals, and descriptions thereof will be omitted.

A terminal device 12 of the present embodiment includes a hash value calculator 21 in addition to the configuration described in the first embodiment.

The hash value calculator 21 calculates a hash value (hereinafter referred to as “hash value a”) that is a value unique to the evidence data. When the terminal device 12 of the present embodiment generates captured data to be used as evidence data, the hash value calculator 21 calculates a captured data hash value (hash value a) from the captured Base64 data. Then, the terminal device 12 adds a hash value a to the registration data shown in FIG. 4B, and transmits the data to the server 14 via the data exchanger 24.

The server 14 of the present embodiment has the same configuration as described in the first embodiment, but the comparator 34 compares the received hash value a and the hash value A calculated by the first hash value calculator 30.

Further, when the comparator 34 determines that the hash value a and the hash value A are the same, the server 14 generates user confirmation data and transmits it to the terminal device 12. Thereafter, the evidence data confirmation process and the evidence data registration process described in the first embodiment are performed, and the captured data is stored in the storage device 16, thereby registering the evidence data.

### Third Embodiment

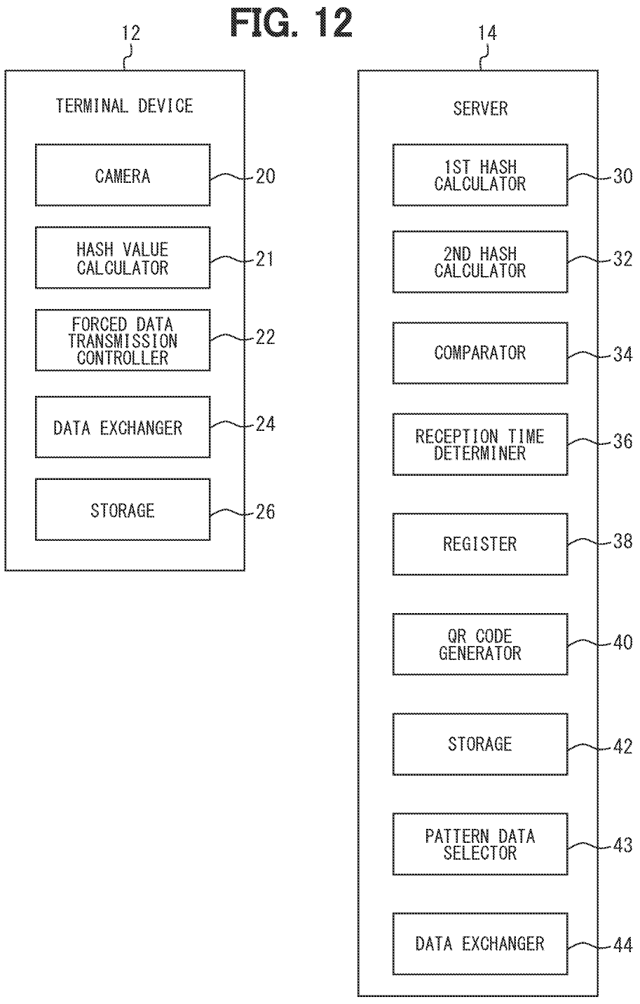

A data authenticity proving system 10 of the present embodiment will be described in the following. FIG. 12 is a schematic configuration diagram of the data authenticity proving system 10 of the present embodiment. Note that configurations in FIG. 12 that are similar to those in FIG. 11 are designated by the same reference numerals, and description thereof will be omitted.

A server 14 includes a pattern data selector 43, and the storage 42 stores a plurality of pattern data each representing a different predetermined rule.

The pattern data selector 43 selects one pattern data from among a plurality of pattern data. The pattern data selected by the pattern data selector 43 is transmitted to the terminal device 12 via the data exchanger 44. The hash value A calculated by the terminal device 12 changes based on a rule (hereinafter referred to as a “pattern”) indicated by pattern data. Note that, in the following description, a hash value that has been modified based on a pattern will be referred to as a modified hash value.

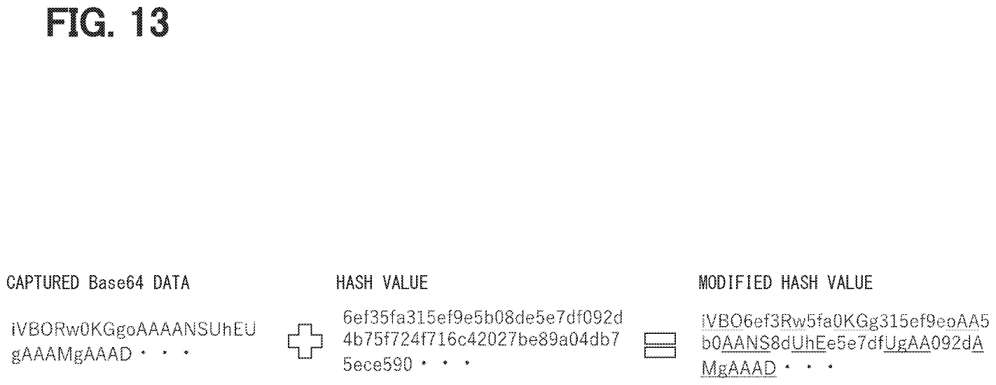

As an example of the pattern, as shown in a schematic diagram of FIG. 13, the captured Base64 data is mixed with the captured data hash value calculated from the captured Base64 data. In the modified hash value shown in FIG. 13, underlined character strings are captured Base64 data mixed with the original hash value. Note that the pattern is not limited to such form, and may also be, for example, a rule for mixing predetermined character strings in a hash value, a rule for rearranging a calculated hash value, or the like.

The hash value calculator 21 included in the terminal device 12 changes the calculated captured data hash value (hash value a) based on the pattern data received from the server 14 to acquire a modified hash value. The modified hash value is transmitted to the server 14 via the data exchanger 44 along with the registration data.

When the server 14 receives the registration data and the modified hash value from the terminal device 12, it temporarily stores them in the storage 42. Then, based on the pattern data transmitted to the terminal device 12, the modified hash value is decoded to restore the original captured data hash value (hash value a). Then, the first hash value calculator 30 calculates a captured data hash value (hash value A) from the captured Base64 data included in the registration data, and the comparator 34 compares the hash value a and the hash value A.

Note that, without restoring the original captured data hash value, the server 14 may change the captured data hash value calculated by the first hash value calculator 30 to the modified hash value based on the pattern data, and may compare the modified hash value and the modified hash value received from the terminal device 12. Further, the server that transmits the pattern data to the terminal device 12 may be a server different from the server 14.

According to the data authenticity proving system 10 of the present embodiment, since the hash value a calculated from the evidence data is changed in a predetermined pattern and is transmitted from the terminal device 12 to the server 14, it becomes more difficult to falsify the evidence data during the data transmission process from the terminal device 12 to the server 14.

(Modification of Third Embodiment)

In case that the evidence data is changed using a pattern data, the evidence data does not have to be hashed.

For example, in one scenario, the terminal device 12 changes the captured Base64 data of the evidence data based on the pattern data, and transmits the post-change captured Base64 data (hereinafter referred to as “changed evidence data”) to the server 14 together with the registration data. When the server 14 receives the registration data and the changed evidence data, the server 14 restores the original captured Base64 data from the changed evidence data based on the pattern data, and compares the restored captured Base64 data and the captured Base64 data included in the registration data, and if they are the same, the evidence data is registered in the storage device 16.

### Fourth Embodiment

The hash value calculation method by the hash value calculator 21 included in the terminal device 12 is not limited to the calculation method described in the above embodiment, but may also be any other calculation method.

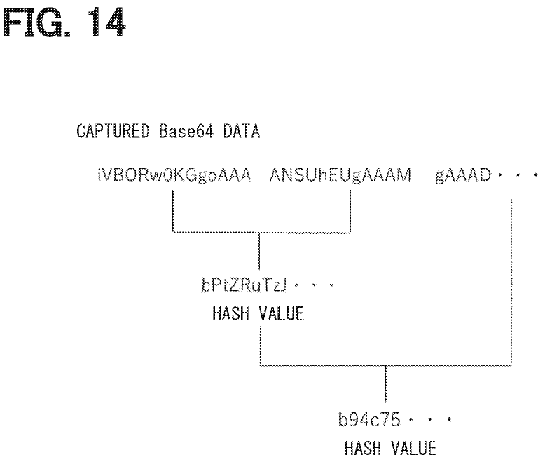

A hash value calculator 21 may calculate the hash value a from data divided into a plurality of data pieces. As a specific example, the hash value calculator 21 may divide the captured Base64 data into a plurality of pieces, calculate a Merkle hash from the divided data, and use the result as the hash value a. In the example of FIG. 14, the captured Base64 data is divided into three pieces, a first divided data, a second divided data are used to calculate a hash value, and then the hash value a is calculated from the hash value and the third divided data.

Alternatively, for example, image data to be used as evidence data may be divided into a plurality of pieces, a hash value may be calculated for each of one or more pieces of divided image data, which may then be used as the hash value a.

Further, when the evidence data is video data, the video data is divided at regular intervals, a hash value is calculated for each of the divided video data, which may then be arranged in chronological order to serve as the hash value a. In such case, a hash value may be calculated from the video data at predetermined time intervals (for example, every 3 seconds) and transmitted to the server 14 while video data is being captured. That is, hash values are calculated at predetermined time intervals while capturing a video. Furthermore, a Merkle hash may be calculated from a plurality of hash values arranged in chronological order, and such Merkle hash may be used as a comparison target for proving the authenticity of evidence data. Alternatively, still image data may be acquired from the video data at predetermined time intervals, and a hash value for authentication may be calculated from the still image data.

Alternatively, the hash value a may be calculated from other data (hereinafter referred to as “additional data”) added to the evidence data. The additional data is, for example, metadata such as EXIF (Exchangeable Image File Format) added to the image data or the like. Note that the hash value may be calculated only from the additional data, or may be calculated from the image data and the additional data.

Note that the first hash value calculator 30 of the server 14 calculates the hash value A of the evidence data received from the terminal device 12 using a method similar to the method of calculating the hash value a by the hash value calculator 21 of the terminal device 12, and the hash value a and hash value A are compared by the comparator 34.

On the other hand, when comparing the hash value A and the hash value B calculated by the server 14, the first hash value calculator 30 and the second hash value calculator 32 respectively calculate the temporarily stored hash value described in the first embodiment. That is, in comparing the hash value A and the hash value B, the hash value is not calculated from the data divided into multiple pieces nor from the additional data.

### Fifth Embodiment

The terminal device 12 of the present embodiment has a function of dividing the storage area (memory space) of the storage 26 into a normal world and a secure world. The normal world is a normal storage area where data can be accessed, and the secure world is a storage area where access to data is restricted. That is, the secure world is a highly secure execution environment that is separated from the normal world, which is a normal execution environment. When the terminal device 12 of the present embodiment cannot access a network, the storage area is divided into a normal world and a secure world by switching an operation mode of a CPU.

When the terminal device 12 having such a function cannot transmit the generated evidence data to the server 14 due to disabled data exchange with the server 14, the terminal device 12 stores the evidence data in the secure world. In such manner, in a state where the terminal device 12 cannot access the network and temporarily stores the evidence data in the terminal device 12, the evidence data is protected from tampering by other external devices and the normal world. Note that if the terminal device 12 has come to be able to access the network after storing the evidence data in the secure world, the evidence data is transmitted to the server 14.

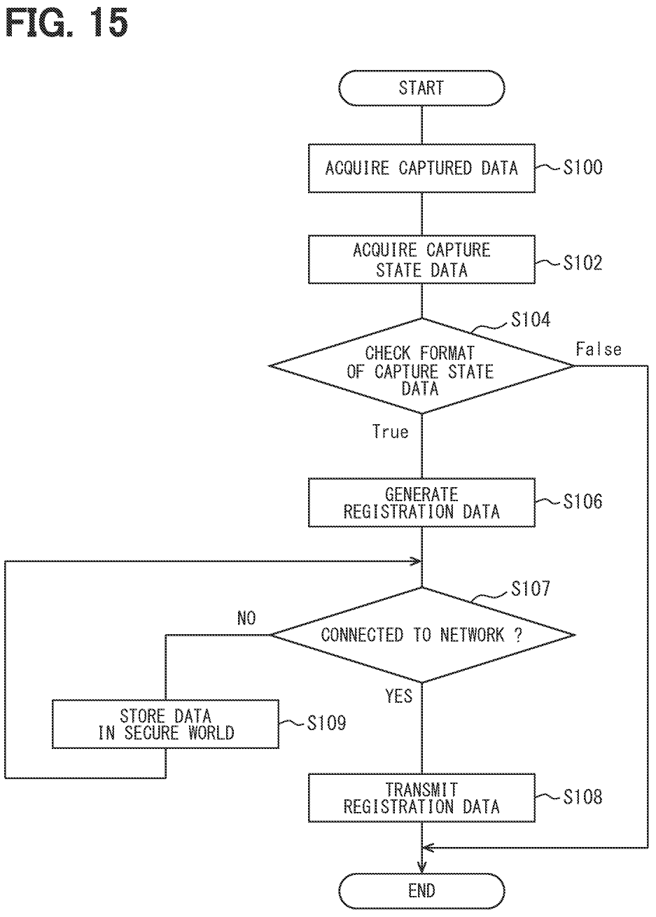

FIG. 15 is a flowchart showing a flow of an evidence data transmission process according to the present embodiment. Note that the steps in FIG. 15 that are the same as those in FIG. 3 are given the same reference numerals as in FIG. 3, and the explanation thereof will be partially or completely omitted.

In the evidence data transmission process of the present embodiment, after the registration data is generated in step S106, the process shifts to step S107.

In step S107, it is determined whether the terminal device 12 is connected to the network, and if the determination is positive, the process shifts to step S108, and if the determination is negative, the process shifts to step S109.

In step S108, the registration data is transmitted to the server 14, and the present evidence data transmission process ends.

On the other hand, in step S109, the registration data is stored in the secure world of the storage 26, in which the registration data is stored until the terminal device 12 is connected to the network, to shift the process to step S107. Note that when the registration data stored in the secure world is transmitted to the server 14, the registration data is deleted from the secure world.

(Sixth Embodiment) In the above-described embodiment, the QR code is issued after registration of the evidence data. However, in the present embodiment, a different scheme is explained in which a QR code indicating identification information (evidence ID or management information ID, hereinafter referred to as “ID”) of the evidence data is issued in advance and evidence data is registered in the storage device 16 in association with an ID indicated by the QR code.

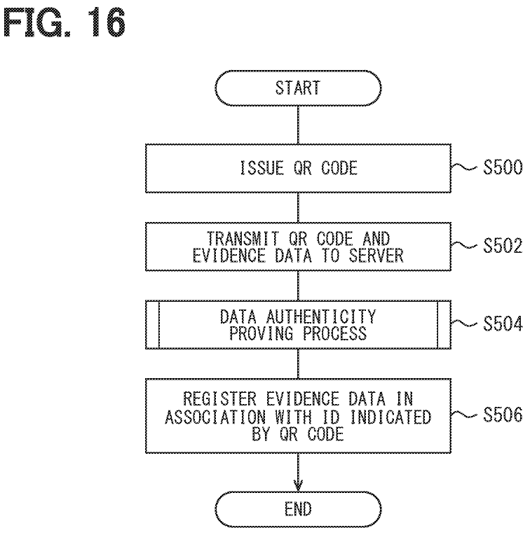

FIG. 16 is a flowchart showing a flow of a QR code pre-issuance process.

First, in step S500, a QR code is issued to a user. An ID of the evidence data is recorded in advance in this QR code. The QR code may be issued by being printed, text-printed, marked, or the like on paper such as a label using a printing device and distributed to the user, or may be sent to the user's terminal device 12 as Base64 data. Note that not only the ID of the evidence data but also other information may be recorded in advance in the issued QR code. Other information mentioned above includes, for example, information about a subject, and/or information about the user who generated the evidence data, and the like when the evidence data is the captured data, e.g., a photograph.

In the next step S502, the terminal device 12 transmits the evidence data and QR code generated by the terminal device 12 to the server 14. Note that if the QR code is printed on a label or the like and issued, the user reads the QR code using the terminal device 12 and transmits the read information to the server 14. Note that the information read from the QR code is, for example, data in the Base64 format of the QR code, but is not limited thereto, and may be data in other formats.

In the next step S504, the data authenticity proving process described in the above embodiment is performed.

In the next step S506, the register 38 of the server 14 registers the evidence data whose authenticity has been proven in the storage device 16 in association with the ID indicated by the QR code.

Although the present disclosure has been described in the above using the above-described embodiments, the technical scope of the present disclosure is not limited to the range described in those embodiments. Various changes or improvements can thus be made to the embodiments described above without departing from the gist of the disclosure, and embodiments with such changes or improvements are also included within the technical scope of the present disclosure.

For example, in the embodiment described above, the evidence data is image data of a still image, but the present invention is not limited thereto, and the evidence data may also be data other than the image data. For example, various data may serve as the evidence data, such as moving image data, audio data, text data, numerical data, data detected by a sensor and the like. Furthermore, in the above embodiment, the case in which location information (e.g., latitude and longitude) is added to the evidence data has been described. However, the evidence data may also include other information such as user ID in addition to or in place of the location information.

Further, in the embodiment described above, a mode in which the evidence data is generated by the terminal device 12 has been described. However, the present invention is not limited thereto, and the evidence data may also be generated by a device different from the terminal device 12. For example, captured data acquired by a digital camera that does not have a communication function to the Internet may be transmitted to the terminal device 12, and the terminal device 12 may transmit the captured data to the server 14 as the evidence data.

Further, in the above embodiment, a mode in which a QR code serves as an information code indicating registered information of evidence data stored in the storage device 16 has been described. However, the information code is not limited thereto, and the information code may also be other two-dimensional code or may also be issued in various formats such as a URL (Uniform Resource Locator) and the like.

In addition, in the above embodiment, the authentication value calculated from and unique to the evidence data is used as a hash value. However, the authentication value is not limited thereto, and may also be any other value as long as it is an irreversible value calculated from the evidence data.

Furthermore, in the evidence data transmission process of the present embodiment shown in FIG. 3, the evidence data is described as being transmitted to the server 14 without being stored in the terminal device 12. However, the evidence data may be left stored in the storage 26 of the terminal device 12, after transmission to the server 14. In such case, it may be preferable that the evidence data is stored in a storage area (secure world) where access to the data is restricted.

Further, the process flow described in the above-described embodiment is only an example, and unnecessary steps may be deleted therefrom, new steps may be added thereto, or the process order may be changed without departing from the gist of the present disclosure.

What is claimed is:

1. A data authenticity proving system that is configured to prove that data received by a server from a terminal device operated by a user is not tampered with, the data authenticity proving system comprising:
a first authentication value calculator that is configured to calculate a first authentication value that is a value uniquely associated with the data at a first timing;
a second authentication value calculator that is configured to calculate a second authentication value that is a value uniquely associated with the data at a second timing different from the first timing of calculating the first authentication value by the first authentication value calculator;
a comparator that is configured to compare the first authentication value and the second authentication value; and
a register that is configured to register the data by storing the data in a storage device when the comparator determines that the first authentication value is equal to second authentication value.

2. The data authenticity proving system of claim 1, wherein
the terminal device is configured to generate the data and transmit the data to the server without storing the data in the terminal device.

3. The data authenticity proving system of claim 1, wherein
the server includes the first authentication value calculator, the second authentication value calculator, the comparator, and the register,
the first authentication value calculator is configured to calculate the first authentication value from the data received from the terminal device, and
the second authentication value calculator is configured to calculate the second authentication value from the data after (a) the first authentication value was calculated and (b) the user confirmed, using the terminal device, the data as target data to be registered.

4. The data authenticity proving system of claim 3, wherein
the terminal device includes an authentication value calculator that is configured to calculate an authentication value that is a value uniquely associated with the data and is configured to transmit the data and the authentication value to the server, and
the comparator in the server is configured to compare the first authentication value and the second authentication value after comparing the authentication value and the first authentication value.

5. The data authenticity proving system of claim 4, wherein
the authentication value calculator is configured to acquire the authentication value by changing the calculated authentication value based on a predetermined rule.

6. The data authenticity proving system of claim 4, wherein
the authentication value calculator and the first authentication value calculator are configured to calculate the authentication value and the first authentication value from the data divided into a plurality of data pieces.

7. The data authenticity proving system according to claim 4, wherein
the authentication value calculator and the first authentication value calculator are configured to calculate the authentication value and the first authentication value from other data added to the data.

8. The data authenticity proving system of claim 1, further comprising:
a determiner that is configured to determine that the received data is not authentic when a time difference between a timing of receiving the data and a timing of generating the data exceeds a predetermined time.

9. The data authenticity proving system of claim 2, wherein
when the terminal device cannot transmit and receive the data to/from the server and cannot transmit generated data to the server, the terminal device is configured to store the data in a storage area where access to the data is prohibited.

10. The data authenticity proving system of claim 1, wherein
the server includes an information code generator that is configured to generate an information code used for reading the data stored in the storage device, and
the information code is transmitted from the server to the terminal device.

11. The data authenticity proving system of claim 1, wherein
information code indicative of identification information of the data is generated in advance,
the terminal device is configured to transmit the information code and the data to the server, and
the register is configured to register the data in the storage device in association with identification information indicated by the information code.

12. A data authenticity proving method for proving that data received by a server from a terminal device operated by a user is not tampered with, the data authenticity proving method comprising:
calculating a first authentication value that is a value uniquely associated with the data and is calculated at a first timing;
calculating a second authentication value that is a value uniquely associated with the data and is calculated at a second timing different from the first timing of calculating the first authentication value by the first authentication value calculator;
comparing the first authentication value and the second authentication value; and
registering the data by storing the data in a storage device when the comparator determines that the first authentication value is equal to the second authentication value.

13. A data authenticity proving system that is configured to prove that data received by a server from a terminal device operated by a user is not tampered with, the data authenticity proving system comprising:
at least one processor; and
at least one memory storing computer program code, wherein
the at least one memory and the computer program code are configured, with the at least one processor, to case the data authenticity proving system to:
calculate a first authentication value that is a value uniquely associated with the data at a first timing;
calculate a second authentication value that is a value uniquely associated with the data at a second timing different from the first timing of calculating the first authentication value;
compare the first authentication value and the second authentication value; and
register the data by storing the data in a storage device upon determining that the first authentication value is equal to second authentication value.
